(19) United States
(12) Patent Application Publication
(10) Pub. No.: US 2008/0157659 A1
(43) Pub. Date: Jul. 3, 2008

(54) ELECTRONIC DEVICE INCLUDING AN ORGANIC DEVICE LAYER

(76) Inventor: Shiva Prakash, Santa Barbara, CA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/960,856

(22) Filed: Dec. 20, 2007

Related U.S. Application Data
(60) Provisional application No. 60/877,507, filed on Dec. 28, 2006.

(51) Int. Cl. H01J 1/63; H01J 9/00

(52) U.S. Cl. 313/504; 445/24

(57) ABSTRACT

An electronic device can include a charge-selective layer and an organic active layer. In one embodiment, the electronic device can include a first pixel including a charge-transport layer, and a first portion of a first organic active layer and a second pixel including a second portion of the first organic active layer and substantially none of the charge-transport layer. In another embodiment, the process of forming the electronic device can include selectively depositing a charge-transport layer over the first electrode and not the second electrode, and depositing a second organic active layer over the first electrode and the second electrode. In yet another embodiment, the process can include liquid depositing a first charge selective layer over a first and second electrode and forming a second charge selective layer over the second electrode and not the first electrode.

### BACKGROUND INFORMATION

1. Field of the Disclosure

This disclosure relates in general to organic electronic devices and, more specifically to electronic devices including a charge-selective layer and an organic layer and processes of forming them.

2. Description of the Related Art

Electronic devices, including organic electronic devices, continue to be more extensively used in everyday life. Examples of organic electronic devices include Organic Light-Emitting Diodes (“OLEDs”). An organic active layer of an OLED can be challenging and expensive to form when producing a reliable three-color display using organic active materials. One method is to deposit the organic active materials using a liquid deposition process. However, the materials known to form longer lasting OLEDs can be difficult to place in solution and may be unstable when exposed to the air. Another method is to deposit the organic material using a vapor deposition process. However, vapor depositing such a material may be too slow to be practical when the material has a relatively low vapor pressure, such as large molecule material. Precise placement of vapor-deposited layers relative to each other within an electronic device can also be problematic. Fall out due to spill over and unwanted intermixing of organic active materials during manufacturing can limit the yield using such a process.

In other methods, a three-color display is produced by forming a first, second, and third anode, and then selectively depositing a first luminescent layer over the first anode, a second luminescent layer over the second anode, and leaving the third anode exposed. In one method, a hole-injection and transfer layer is deposited over the third anode such that the material of the hole-injection and transfer layer intermixes with a subsequently deposited third luminescent layer. In another method, a third luminescent layer is blanket deposited directly onto the third electrode. Such methods place material of the third luminescent layer in contact with the third anode, thus requiring that any material of the third luminescent layer be compatible with the material of the third anode as well as any other material exposed at the time of deposition, such as the material of the first or second luminescent layers. The additional compatibility requirement restricts the possible combinations of material that can be used to form the three-color display.

### SUMMARY

An electronic device can include a charge-selective layer and an organic active layer. In a first aspect, the electronic device can include a first pixel including a charge-transport layer, and a first portion of the first organic active layer overlying the charge-transport layer. The electronic device can also include a second pixel including a second organic active layer, a second portion of the first organic active layer overlying the second organic active layer, wherein substantially none of the charge-transport layer lies within the second pixel.

In a second aspect a process of forming an electronic device can include forming a first electrode and a second electrode over a substrate, and selectively depositing a first organic active layer over the second electrode and not the first electrode. The process can also include selectively depositing a charge-transport layer over the first electrode and not the second electrode, and depositing a second organic active layer over the first electrode and the second electrode.

In a third aspect, a process of forming an electronic device can include forming a first electrode and a second electrode over a substrate, and depositing a first charge-selective layer over the first electrode and the second electrode. The process can also include liquid depositing a first organic active layer over the first electrode and not the second electrode, and depositing a second charge-selective layer over the second electrode and not the first electrode. The process can further include depositing a second organic active layer over the first organic active layer and the second charge-selective layer.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1 includes as illustration of a cross-sectional view of a workpiece including a substrate, electrodes, and a charge-selective layer.

FIG. 2 includes an illustration of a cross-sectional view of the workpiece of FIG. 1 after forming an organic active layer.

FIG. 3 includes an illustration of a cross-sectional view of the workpiece of FIG. 2 after forming a charge-selective layer.

FIG. 4 includes an illustration of a cross-sectional view of the workpiece of FIG. 3 after forming an organic active layer.

FIG. 5 includes an illustration of a cross-sectional view of a substantially complete electronic device.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

An electronic device can include a charge-selective layer and an organic active layer. In a first aspect, the electronic device can include a first pixel including a charge-transport layer, and a first portion of the first organic active layer overlying the charge-transport layer. The electronic device can also include a second pixel including a second organic active layer, a second portion of the first organic active layer overlying the second organic active layer, wherein substantially none of the charge-transport layer lies within the second pixel.

In a particular embodiment of the first aspect, the first pixel can further include a first charge-selective layer spaced-apart from the first portion of the first organic active layer, and the second pixel can further include a second charge-selective layer spaced-apart from the from the second portion of the first organic active layer. In a more particular embodiment, within the first pixel, the charge-transport layer can lie between the first charge-selective layer and the first portion of the first organic active layer, and within the second pixel, the second organic active layer can lie between the second charge selective layer and the second portion of the first organic active layer.

In another particular embodiment of the first aspect, the first organic active layer can include a small molecule material. In a more particular embodiment, the second organic active layer can include a large molecule material. In another embodiment, the first organic active layer and the second organic active layer can include different organic active materials.

In still another particular embodiment, the first pixel can further include a first electrode, wherein each of the charge-transport layer and the first charge-selective layer lies between the first portion of the first organic active layer and the first electrode. Also, the second pixel can further include a second electrode, wherein each of the second charge-selective layer and the second organic active layer lies between the second portion of the first organic active layer and the second electrode. In a more particular embodiment, the first charge-selective layer and the second charge-selective layer each include a portion of a same charge-selective layer.

In a second aspect a process of forming an electronic device can include forming a first electrode and a second electrode over a substrate, and selectively depositing a first organic active layer over the second electrode and not the first electrode. The process can also include selectively depositing a charge-transport layer over the first electrode and not the second electrode, and depositing a second organic active layer over the first electrode and the second electrode.

In one embodiment of the second aspect, selectively depositing the charge-transport layer can include using a liquid deposition technique. In a particular embodiment, depositing a second organic active layer can be performed after depositing the charge-transport layer. In a more particular embodiment, depositing the second organic active layer can include using blanket deposition technique. In another more particular embodiment, selectively depositing the first organic active layer over the second electrode can be performed prior to selectively depositing the charge-transport layer. In a still more particular embodiment, depositing the first organic active layer can include using a liquid deposition technique.

In another embodiment of the second aspect, the process can further include depositing a charge-selective layer over the first electrode and the second electrode prior to forming the charge-transport layer. In still another embodiment, depositing the charge-selective layer includes using a liquid deposition technique.

In a third aspect, a process of forming an electronic device can include forming a first electrode and a second electrode over a substrate, and depositing a first charge-selective layer over the first electrode and the second electrode. The process can also include liquid depositing a first organic active layer over the first electrode and not the second electrode, and depositing a second charge-selective layer over the second electrode and not the first electrode. The process can further include depositing a second organic active layer over the first organic active layer and the second charge-selective layer.

In one embodiment of the third aspect, depositing the first charge-selective layer can include using a liquid deposition technique. In another embodiment, depositing the second charge-selective layer can include using a liquid deposition technique. In still another embodiment, depositing the second organic active layer includes using a vapor deposition technique.

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Fabrication of an Electronic Device, Electronic Device and Its Operation, and finally, Advantages.

### 1. DEFINITIONS AND CLARIFICATION OF TERMS

Before addressing details of embodiments described below, some terms are defined or clarified.

The term “blue light” is intended to mean radiation that has an emission maximum at a wavelength in a range of approximately 400 to 500 nm.

The term “blue light-emitting layer” is intended to mean a layer capable of emitting radiation that has an emission maximum at a wavelength in a range of approximately 400 to 500 nm.

The term “buffer layer” or “buffer material” is intended to indicate a layer or material that is electrically conductive or semiconductive materials and may have one or more functions in an organic electronic device, including planarization of the underlying layer, charge-transport or charge-injection properties, scavenging of impurities such as oxygen or metal ions, and other aspects to facilitate or to improve the performance of the organic electronic device. Buffer Materials may be polymers, solutions, dispersions, suspensions, emulsions, colloidal mixtures, or other compositions.

The term “charge-blocking,” when referring to a layer, material, member, or structure, is intended to mean such layer, material, member or structure reduces the likelihood that a charge migrates into another layer, material, member or structure.

The term “charge-injecting,” when referring to a layer, material, member, or structure, is intended to mean such layer, material, member or structure promotes charge migration into an adjacent layer, material, member or structure.

The term “charge-selective,” is intended to mean charge-blocking, charge-injecting, charge-transport, or any combination thereof. A charge-selective layer is not an organic active layer.

The term “charge-transport,” when referring to a layer, material, member, or structure, is intended to mean such layer, material, member, or structure facilitates migration of such charge through the thickness of such layer, material, member, or structure with relative efficiency and small loss of charge.

The term “continuous printing” and its variants is intended to mean printing using a substantially unbroken stream of a liquid or a liquid composition, as opposed to a deposition technique using drops.

The term “green light” is intended to mean radiation that has an emission maximum at a wavelength in a range of approximately 500 to 600 nm.

The term “green light-emitting layer” is intended to mean a layer capable of emitting radiation that has an emission maximum at a wavelength in a range of approximately 500 to 600 nm.

The term “large molecule,” when referring to a compound, is intended to mean a compound which has repeating monomeric units. In one embodiment, a large molecule has a molecular weight greater than 2,000 g/mol.

The term “organic active layer” is intended to mean one or more organic layers, wherein at least one of the organic layers, by itself, or when in contact with a dissimilar material is capable of forming a rectifying junction, and emits or responds to radiation at a targeted wavelength or spectrum of wavelengths.

The term “pixel” is intended to mean a portion of an array corresponding to one electronic component and its corresponding electronic component(s), if any, that are dedicated to that specific one electronic component. In one embodiment, a pixel has an OLED and its corresponding pixel control circuit. Note that a pixel as used in this specification can be a pixel or subpixel as those terms are used by skilled artisans outside of this specification. For example, in a full-color display, a pixel typically produces a red, green, or blue light. In a monochromatic display, substantially all pixels produce radiation having a substantially same spectrum. A sensor array may or may not include pixels that respond to different spectral ranges.

The term “precision deposition technique” is intended to mean a selective deposition technique capable of forming a pattern over a substrate including a feature or a substantially open region having a smallest dimension as small as 1 mm from a top view. A stencil mask, frame, well structure, patterned layer, or other structure(s) may or may not be present during such a deposition.

The term “radiation-emitting component” is intended to mean an electronic component, which when properly biased, emits radiation at a targeted wavelength or spectrum of wavelengths. The radiation may be within the visible-light spectrum or outside the visible-light spectrum (UV or IR). A light-emitting diode is an example of a radiation-emitting component.

The term “radiation-responsive component” is intended to mean an electronic component, which when properly biased, can respond to radiation at a targeted wavelength or spectrum of wavelengths. The radiation may be within the visible-light spectrum or outside the visible-light spectrum (UV or IR). An IR sensor and a photovoltaic cell are examples of radiation-sensing components.

The term “rectifying junction” is intended to mean a junction within a semiconductor layer or a junction formed by an interface between a semiconductor layer and a dissimilar material, in which charge carriers of one type flow easier in one direction through the junction compared to the opposite direction.

The term “red light” is intended to mean radiation that has an emission maximum at a wavelength in a range of approximately 600 to 700 nm.

The term “red light-emitting layer” is intended to mean a layer capable of emitting radiation that has an emission maximum at a wavelength in a range of approximately 600 to 700 nm.

The term “small molecule,” when referring to a compound, is intended to mean a compound which does not have repeating monomeric units. In one embodiment, a small molecule has a molecular weight no greater than 2000 g/mol.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. FABRICATION OF AN ELECTRONIC DEVICE

FIG. 1 includes an illustration of a cross-sectional view of a workpiece 10 including a substrate 12. In one embodiment, the workpiece 10 includes electrodes 14, 16, and 18. The workpiece 10 can also include an organic layer 110. In the illustrated embodiment, the organic layer 110 includes a charge-selective layer 112 and a charge-selective layer 114.

The substrate 12 can be either rigid or flexible and may include one or more layers of one or more materials, which can include, but are not limited to, glass, polymer, metal or ceramic materials or combinations thereof. In one embodiment, the substrate 12 is substantially transparent to a targeted wavelength or spectrum of wavelengths associated with the electronic device. Pixel control or other circuits (not illustrated) can be formed within or over the substrate 12 using conventional or proprietary techniques.

The electrode 14 can serve as an electrode for an electronic component, such as an OLED. In one embodiment, the electrode 14 has a work function of approximately 4.4 eV or higher and acts as an anode for the electronic component. In one particular embodiment, the electrode 14 includes InSnO, AlZnO, AlSnO, ZrSnO, another suitable material used for an anode in an OLED, or any combination thereof.

The electrode 14 can be formed by a deposition using a conventional or proprietary technique. The electrode 14 may have a thickness in a range of approximately 10 to 1000 nm. The electrodes 16 and 18 can be formed by an embodiment previously described for the electrode 14. The electrodes 14, 16, and 18 may each include the same or different material, and may each be formed using the same or different technique.

Although not illustrated, a structure (e.g., a well structure, cathode separators, or the like) may lie adjacent the electrodes 14, 16, and 18 to reduce the likelihood of materials from different organic active layers from contacting each other at locations above the electrodes 14, 16, and 18.

The organic layer 110 can be formed over the electrode 14. In the illustrated embodiment, the organic layer 110 also overlies the electrodes 16 and 18. In another embodiment (not illustrated), another organic layer can overlie the electrode 16, 18, or any combination thereof. The organic layer 110 can serve as a charge-selective layer. For example, the organic layer 110 includes a charge-injection layer (electron-injection or hole-injection layer), a charge-transport layer (electron-transport layer or hole-transport layer), a charge-blocking layer (electron-blocking layer or hole-blocking layer), or any combination thereof. Any individual or combination of layers within the organic layer 110 can be formed by a conventional or proprietary deposition technique. Any individual or combination of layers within the organic layer 110 may be cured after deposition.

In one embodiment, the organic layer 110 includes charge-selective layers 112 and 114. In another embodiment, the organic layer 110 includes more or fewer charge-selective layers. The charge-selective layer 112 can include a conventional or proprietary material that is suitable for use in a charge-injection layer (e.g., a doped buffer layer). The charge-selective layers 112 and 114 can include different large molecule materials. In one embodiment, each of the charge-selective layers 112 and 114 includes a large molecule material such as polypyrrole, polyvinylcarbazole, (phenylmethyl)polysilane, poly(dioxythiophenes) (“PEDOT”), polyaniline (“PANI”), another material conventionally used as a hole-transport layer, or any combination thereof. In a more particular embodiment, the charge-selective layer 112 also includes a material such as polystyrene or polycarbonate.

Each of the charge-selective layers 112 and 114 can have a thickness in a range of approximately 2 to 300 nm and may have the same or different thicknesses as compared to each other. In other embodiments, the charge-selective layers 112 and 114 are each thicker or thinner than the range recited above. In one embodiment, each of the charge-selective layers 112 and 114 is formed using a liquid deposition technique. In a particular embodiment, the charge-selective layer 112 is formed by depositing an aqueous solution. In another particular embodiment, the charge-selective layer 114 is formed by depositing an organic solution.

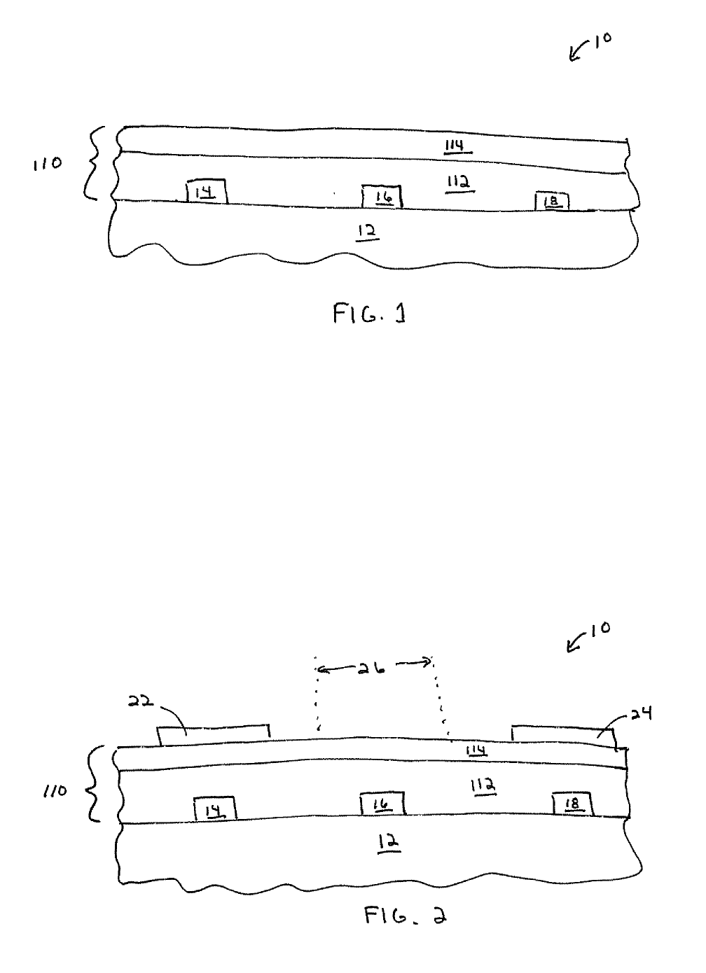

FIG. 2 includes an illustration of the workpiece 10 after forming an organic active layer 22 and an organic active layer 24. In the illustrated embodiment, the organic active layer 22 overlies the electrode 14, and the organic active layer 24 overlies the electrode 18. A portion of the organic layer 110 over the electrode 16 can lie exposed within an opening 26 between the organic active layers 22 and 24.

In one embodiment, each of the organic active layers 22 and 24 serves as an electroluminescent (“EL”) layer in an OLED. In one embodiment, the organic active layers 22 and 24 emit a portion of the visible light spectrum. In a more particular embodiment, the organic active layers 22 and 24 include different radiation-emitting materials and emit a significantly different spectrum of light. In a still more particular embodiment, the organic active layer 22 emits a green light and the organic active layer 24 emits a red light. In another still more particular embodiment, the organic active layer 22 emits a green light and the organic active layer 24 emits a blue light. In yet another embodiment, the organic active layers 22 and 24 are used in a radiation-responsive component, such as a radiation sensor, photovoltaic cell, or the like.

The organic active layers 22 and 24 can include material(s) conventionally used as organic active layers in organic electronic devices and can include one or more small molecule materials, one or more large molecule materials, or any combination thereof. In one embodiment, organic active layers 22 and 24 include different large molecule materials.

The organic active layers 22 and 24 can each have a thickness in a range of approximately 40 to 100 nm, and in a particular embodiment, a thickness in a range of approximately 70 to 90 nm. In another embodiment, the organic active layers 22 and 24 have the same or different thickness.

In a particular embodiment, the organic active layer 22, the organic active layer 24, or any combination thereof, are deposited using a conventional or proprietary liquid deposition technique. In a more particular embodiment, the liquid deposition process includes a precision deposition process, such as a continuous printing process, an ink-jet printing process, or the like. Each of the organic active layers 22 and 24 can be formed using the same or different processes.

FIG. 3 includes an illustration of the workpiece 10 after forming a charge-selective layer 32 over the electrode 16. The charge-selective layer 32 can lie within the opening 26 such that, from a top view, substantially none of the charge-selective layer 32 overlies the electrode 14, the electrode 18, or any combination thereof. In one embodiment, substantially none of the organic layer 110 remains exposed within the opening 26. The charge-selective layer 32 can serve as a barrier and substantially prevent subsequently deposited materials from contacting the organic layer 110 under the opening 26. The charge-selective layer 32 can also serve to substantially prevent exposure of the organic layer 110 to a detrimental condition during a subsequently performed process. In a particular embodiment, the charge-selective layer 32 serves as a charge-transport layer.

The charge-selective layer 32 can include a charge-transport material, a charge-blocking material, or any combination thereof. In one embodiment, the charge-selective layer 32 includes a small molecule material. In another embodiment, the charge-selective layer 32 includes a large molecule material different from the large molecule material of the charge-selective layer 114. The charge-selective layer 32 can include N,N′-bis(naphthalen-1-yl)-N,N′-bis-(phenyl)benzidine (“α-NPB”), CBP (Carbazole biphenyl), C60 (Buckminsterfullerene), another wide band-gap organic semiconductor, a liquid hole transport material compatible with small molecule light-emitting or light responsive material, or any combination thereof.

The charge-selective layer 32 can have a thickness in a range substantially the same as previously described for the charge-selective layer 114. In a particular embodiment, the charge-selective layer 32 has a thickness in a range of approximately 10 to 50 nm.

The charge-selective layer 32 can be deposited using a conventional or proprietary process such as casting, spin-coating, vapor depositing (chemical or physical), printing (ink jet printing, screen printing, solution dispensing (dispensing the liquid composition in strips or other predetermined geometric shapes or patterns, as seen from a top view), another continuous printing process or any combination thereof), other depositing techniques, or any combination thereof. In a particular embodiment, the charge-selective layer 32 is selectively deposited. In a more particular embodiment, the charge-selective layer 32 is vapor deposited using a stencil mask. In another more particular embodiment, a liquid deposition process such as continuous printing or ink jet printing is used to precisely deposit the charge-selective layer 32.

The charge-selective layer 32 can be cured after deposition. In one embodiment, the charge-selective layer 32 is cured under a substantially non-reactive atmosphere such as nitrogen, helium, argon, or any combination thereof. The cure can have a peak temperature of in a range of approximately 100 to 300 degrees centigrade for a time of up to approximately 30 minutes. In another embodiment, no cure is required for the charge-selective layer 32.

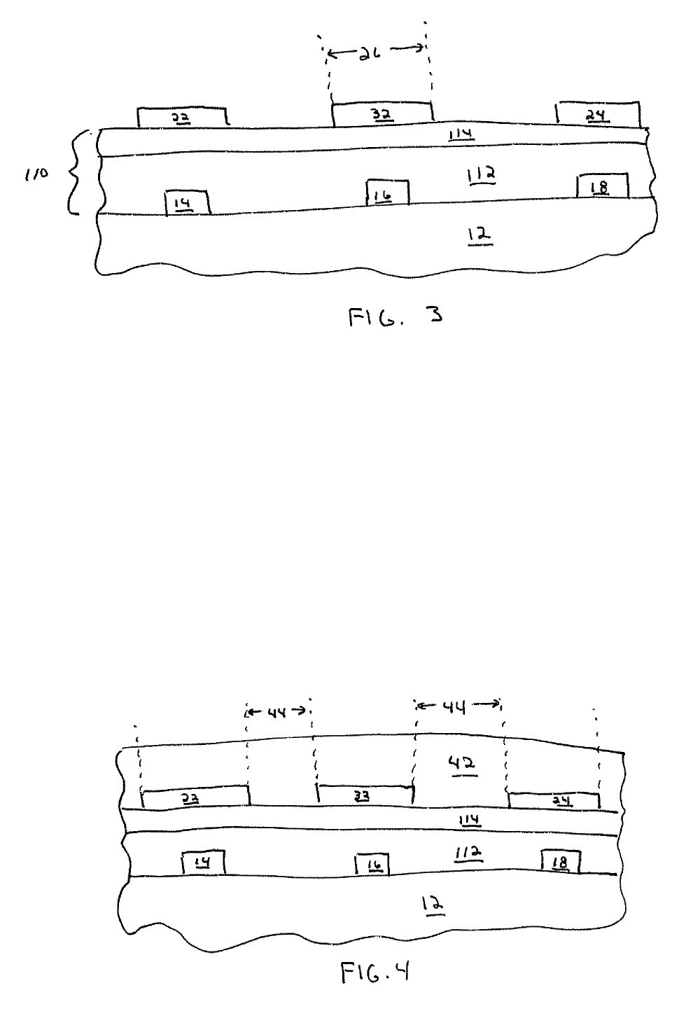

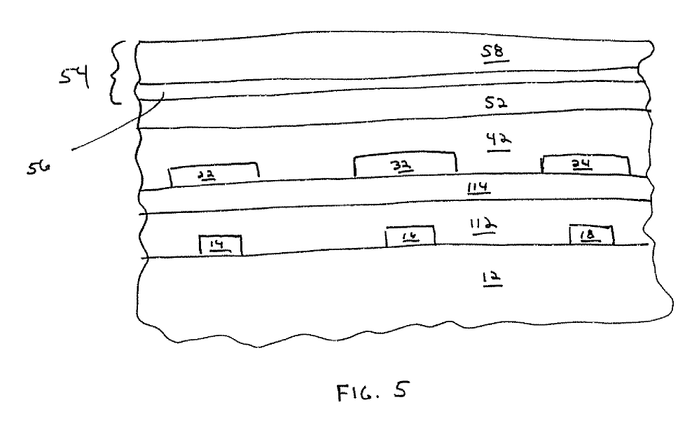

FIG. 4 includes an illustration of the workpiece 10 after forming an organic active layer 42. The organic active layer 42 can overlie the charge-selective layer 32. In one embodiment, the organic active layer 42 is spaced-apart from the organic layer 110 so that material from the organic active layer 42 is substantially prevented from intermixing with material from the organic layer 110. In a particular embodiment, the organic active layer 22, charge-selective layer 32, and the organic active layer 24 can lie between the organic layer 110 and the organic active layer 42

By keeping the organic active layer 42 substantially separated from the organic layer 110, materials interactions can be avoided, making a wider selection of material combinations available for forming the electronic device. In one embodiment, substantially none of the organic active layer 22 or the organic active layer 24 lies between the organic active layer 42 and the electrode 16.

In one embodiment, the organic active layer 42 serves as an EL layer in an OLED. In another embodiment, the organic active layer 42 emits a portion of the visible light spectrum. In a particular embodiment, the organic active layer 42 emits either red or blue light. In still another embodiment, the organic active layer 42 is used in a radiation-responsive component, such as a radiation sensor, photovoltaic cell, or the like.

The organic active layer 42 can include a radiation-emitting or radiation-responsive compound, metal complex, conjugated polymer, or any combination thereof typically used in an OLED display. Examples of radiation-emitting or radiation-responsive compounds include pyrene, perylene, rubrene, coumarin, derivatives thereof, or any combination thereof. Examples of radiation-emitting or radiation-responsive metal complexes include metal chelated oxinoid compounds, such as tris(8-hydroxyquinolato)aluminum (Alq3); cyclometalated iridium, or platinum electroluminescent compounds, such as complexes of iridium with phenylpyridine, phenylquinoline, or phenylpyrimidine ligands as disclosed in U.S. Pat. No. 6,670,645 and Published PCT Applications WO 03/063555 and WO 2004/016710, or organometallic complexes described in, for example, Published PCT Applications WO 03/008424, WO 03/091688, and WO 03/040257, or any combination thereof. Electroluminescent emissive layers comprising a charge carrying host material and a metal complex have been described in U.S. Pat. No. 6,303,238, and published PCT applications WO 00/70655 and WO 01/41512. Examples of radiation-emitting or radiation-responsive conjugated polymers include poly(phenylenevinylenes), polyfluorenes, poly(spirobifluorenes), polythiophenes, poly(p-phenylenes), copolymers thereof, or any combination thereof. In one embodiment, the organic active material in the organic active layer 42 is a different organic active material than the organic active materials in either of the organic active layers 22 or 24. In still another embodiment, the organic active layer 42 includes a small molecule material, and in yet another embodiment, the organic active layer 42 is capable of emitting or responding to either a red or blue light. In a particular embodiment, the organic active layer 42 is incompatible with the organic layer 110.

The organic active layer 42 can be deposited over the charge-selective layer 32, the electrode 14, the electrode 16, the electrode 18, or any combination thereof using a conventional or proprietary technique previously described for the charge-selective layer 32. In one embodiment, the organic active layer 42 is deposited using a vapor deposition process. In another embodiment, the organic active layer 42 is deposited using a blanket deposition technique. The organic active layer 42 can have a thickness in a range of approximately 15 to 100 nm. In another embodiment, the organic active layer 42 has a thickness in a range of approximately 15 to 70 nm. In a particular embodiment, the combined thickness of the organic active layer 42 and the charge-selective layer 32 are in a range of approximately 30 to 90 nm. In still another embodiment, the organic active layer 42 has another thickness, either thicker or thinner than the ranges recited above.

FIG. 5 includes an illustration of a cross-sectional view of a substantially complete electronic device including an organic layer 52, an electrode 54. The organic layer 52 is an optional layer. The organic layer 52 can serve as a charge-selective layer. In one embodiment, the organic layer 52 allows charges to be injected from the subsequently formed electrode (e.g., cathode) and transported to the organic active layer 42. In another embodiment, the organic layer 52 includes a conventional or proprietary hole-blocking material, electron injection material, electron-transport material, or any combination thereof. The organic layer 52, if present, typically can have a thickness in a range of approximately 10 to 100 nm. The organic layer 52 can be formed over the organic active layer 42 using a conventional or proprietary process.

In one embodiment, the electrode 54 serves as a cathode. The electrode 54 can be formed by a conventional or proprietary physical deposition technique. In one embodiment, the electrode 54 includes at least one layer deposited through a stencil mask.

In the embodiment illustrated in FIG. 5, the electrode 54 includes an electrode layer 56 and an electrode layer 58. The electrode layer 56 can set the work function for the electrode 54. In one embodiment, when the organic layer 52 is present, the electrode layer 56 lies adjacent to the organic layer 52. In another embodiment (not illustrated), the electrode 54 contacts the organic active layer 42. The electrode layer 56 can include a Group 1 metal, a Group 2 metal, a Group 12 metal, or any combination thereof. In a particular embodiment, the electrode layer 56 includes an element, alloy, salt, or any combination thereof containing a Group 1 element. In a more particular embodiment, the electrode layer 56 includes a lithium-containing material such as LiF, Li₂O, or any combination thereof. The electrode layer 56 can be deposited using a conventional or proprietary technique. In one embodiment, the electrode layer 56 is deposited using vapor deposition through a stencil mask. The electrode layer 56 can have a thickness in a range of approximately 0.3 to 20 nm.

The electrode layer 58 can overlie the electrode layer 56 and, in one embodiment, serves as an encapsulation layer to substantially prevent air from contacting the electrode layer 56. The electrode layer 58 can include Ag, Al, Au, Cu, Pt, Pd, Ti, Ta, W, a transparent conducting oxide, such as InZnO or InSnO, or any combination thereof. The electrode layer 58 can be deposited using a conventional or proprietary technique. In one embodiment, the electrode layer 58 is deposited using vapor deposition through a stencil mask. The electrode layer 58 can have a thickness in a range of approximately 50 to 500 nm. In another embodiment, the electrode layers 56 or 58 can have other thicknesses, either thicker or thinner than the ranges recited above. In still another embodiment, the electrode 54 has a thickness in a range of approximately 1 to 25 microns.

### 3. ELECTRONIC DEVICE AND ITS OPERATION

The electronic device may be used by itself or may be incorporated into a system. For example, the electronic device can be a display that can be incorporated into a monitor for a computer, a television, or a display in a mobile communicating device, or the like.

The electronic device can be operated by providing the proper signals and data to the terminals as illustrated in FIG. 5. Appropriate voltages can be provided to the electrodes 14, 16, 18, and 54. In one embodiment, having radiation-emitting components, the electrodes 14, 16, and 18 can be coupled to a V_{DD} power supply terminal, and the electrode 54 can be coupled to a V_{SS} power supply terminal. In another embodiment, having radiation-responsive components (e.g. sensors), the electrode 54 can be placed at a more positive potential with respect to the electrodes 14, 16, and 18. In a particular embodiment, the electrode 54 can be at a potential of approximately 0 volts, and the electrodes 14, 16, and 18 can be at a potential of approximately −10 volts. When other types of electronic devices are formed (e.g., a photovoltaic array), the voltages or other signals may change accordingly.

### 4. ADVANTAGES

By selectively depositing the charge-selective layer 32, incompatible materials in the organic active layer 42 and the organic layer 110 can be effectively isolated from each other. The charge-selective layer 32 can act as a barrier, effectively maintaining the physical separation of the incompatible materials while still allowing charges to flow and the electronic device to operate. Thus a compatibility requirement can substantially eliminated, improving the selection of materials combinations that can be used to form the electronic device.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. For example, although the specification includes a description of a bottom emitting electronic device, after reading this specifications, skilled artisans should be able to form a top emitting electronic device without undue experimentation. Also, in another embodiment (not illustrated), different pixels within the electronic device may include electrodes having different materials that may not be compatible with the same charge selective layer. In such a case, the charge-selective layer may be selectively deposited over the electrode 16 before forming the charge-selective layer 112, the charge-selective layer 114, or any combination thereof.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. The use of numerical values in the various ranges specified herein is stated as approximations as though the minimum and maximum values within the stated ranges were both being preceded by the word “about.” In this manner slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

What is claimed is:

1. An electronic device comprising:
a first pixel including:
a charge-transport layer; and
a first portion of the first organic active layer overlying the charge-transport layer; and
a second pixel including:
a second organic active layer;
a second portion of the first organic active layer overlying the second organic active layer; wherein substantially none of the charge-transport layer lies within the second pixel.

2. The electronic device of claim 1, wherein:
the first pixel further comprises a first charge-selective layer spaced-apart from the first portion of the first organic active layer; and
the second pixel further comprises a second charge-selective layer spaced-apart from the from the second portion of the first organic active layer.

3. The electronic device of claim 2, wherein:
within the first pixel, the charge-transport layer lies between the first charge-selective layer and the first portion of the first organic active layer; and
within the second pixel, the second organic active layer lies between the second charge selective layer and the second portion of the first organic active layer.

4. The electronic device of claim 1, wherein the first organic active layer includes a small molecule material.

5. The electronic device of claim 4, wherein the second organic active layer includes a large molecule material.

6. The electronic device of claim 1, wherein the first organic active layer and the second organic active layer includes different organic active materials.

7. The electronic device of claim 1, wherein:
the first pixel further comprises a first electrode, wherein each of the charge-transport layer and the first charge-selective layer lies between the first portion of the first organic active layer and the first electrode; and
the second pixel further comprises a second electrode, wherein each of the second charge-selective layer and the second organic active layer lies between the second portion of the first organic active layer and the second electrode.

8. The electronic device of claim 7, wherein the first charge-selective layer and the second charge-selective layer each comprise a portion of a same charge-selective layer.

9. A process of forming an electronic device comprising:
forming a first electrode and a second electrode over a substrate;
selectively depositing a first organic active layer over the second electrode and not the first electrode; and
selectively depositing a charge-transport layer over the first electrode and not the second electrode;
depositing a second organic active layer over the first electrode and the second electrode.

10. The process of claim 9, wherein selectively depositing the charge-transport layer includes using a liquid deposition technique.

11. The process of claim 9, wherein depositing a second organic active layer is performed after depositing the charge-transport layer.

12. The process of claim 11, wherein depositing the second organic active layer includes using blanket deposition technique.

13. The process of claim 11, wherein selectively depositing the first organic active layer over the second electrode is performed prior to selectively depositing the charge-transport layer.

14. The process of claim 13, wherein depositing the first organic active layer includes using a liquid deposition technique.

15. The process of claim 9, further comprising depositing a charge-selective layer over the first electrode and the second electrode prior to forming the charge-transport layer.

16. The process of claim 15, wherein depositing the charge-selective layer includes using a liquid deposition technique.

17. A process of forming an electronic device comprising:
forming a first electrode and a second electrode over a substrate;
depositing a first charge-selective layer over the first electrode and the second electrode;
liquid depositing a first organic active layer over the first electrode and not the second electrode;
depositing a second charge-selective layer over the second electrode and not the first electrode; and
depositing a second organic active layer over the first organic active layer and the second charge-selective layer.

18. A process of claim 17, wherein depositing the first charge-selective layer includes using a liquid deposition technique.

19. A process of claim 17, wherein depositing the second charge-selective layer includes using a liquid deposition technique.

20. A process of claim 17, depositing the second organic active layer includes using a vapor deposition technique.
